(19) United States
(12) Patent Application Publication
(10) Pub. No.: US 2025/0348692 A1
(43) Pub. Date: Nov. 13, 2025

(54) STREAMING SPEECH TO SPEECH TRANSLATION

(71) Applicant: Google LLC, Mountain View, CA (US)

(72) Inventors: Alex Agranovich, Herzlia (IL); Eliya Nachmani, Jerusalem (IL); Oleg Rybakov, Redmond, WA (US); Yifan Ding, Tokyo (JP); Ye Jia, Santa Clara, CA (US); Nadav Bar, Raanana (IL); Byungha Chun, Tokyo (JP); Michelle Dana Tadmor, Tel Aviv (IL)

(21) Appl. No.: 19/202,938

(22) Filed: May 8, 2025

Related U.S. Application Data
(60) Provisional application No. 63/644,450, filed on May 8, 2024.

(51) Int. Cl. G06F 40/58; G10L 13/027

(52) U.S. Cl. CPC G06F 40/58; G10L 13/027

(57) ABSTRACT

Methods, systems, and apparatus, including computer programs encoded on a computer storage medium, for performing speech-to-speech translation, including real-time speech-to-speech translation.

### CROSS-REFERENCE TO RELATED APPLICATIONS

This application claims priority to U.S. Provisional Application No. 63/644,450 filed on May 8, 2024. The disclosure of the prior application is considered part of and is incorporated by reference in the disclosure of this application.

### BACKGROUND

This specification relates to processing inputs using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that can perform speech-to-speech translation. In other words, the system can receive input speech in a first natural language and generate output speech that is a translation of the input speech in a second, different natural language.

In some implementations, the system can perform real-time speech-to-speech translation.

Particular embodiments of the subject matter described in this specification can be implemented so as to realize one or more of the following advantages.

Simultaneous speech-to-speech translation on mobile devices is a major challenge. In recent years, groundbreaking models have revolutionized the field of speech-to-speech translation, however, existing real-time translation models are not optimized for the inherent constraints of mobile devices, e.g., limited memory, limited compute power, heat management, etc.

The techniques in this specification, by contrast, can perform high quality real-time speech-to-speech translation in a lightweight, efficient manner on a mobile device. The techniques described in this specification can process input audio in streaming mode, extract and encode features, and decode in streaming mode, enabling instant translation. The techniques described in this specification can utilize parallelization between the encoder and decoder components, optimizing real-time inference and minimizing latency. This concurrent execution allows the encoder to process a second frame while the decoder operates on a first audio frame that has been encoded by the encoder in the previous time step.

The techniques described in this implementation can utilize reduced model sizes and a specialized framework for resource constrained on-device deployment that includes a significantly smaller memory footprint and an optimized execution, ensuring both low latency and efficient utilization of mobile device hardware.

In other words, when performing speech-to-speech translation, the techniques described in this specification can effectively preserve the natural characteristics of the input speech, such as speaker identity, intonation, and other subtle nuances, while being optimized for the constraints of on-device processing.

The details of one or more embodiments of the subject matter will become apparent from the description, drawings, and the claims.

Other features, aspects, and advantages of the subject matter will become apparent from the description, drawings, and the claims.

### BRIEF DESCRIPTION OF THE DRAWINGS

FIG. 1 shows an example speech-to-speech translation system.

FIG. 2 is a diagram that shows an example speech to speech translation.

FIG. 3 compares the performance of the speech-to-speech translation system with previous models.

FIG. 4 is a flow diagram of an example speech-to-speech translation process.

FIG. 5 is a flow diagram of sub-steps of one of the steps of the example process of FIG. 4.

Like references numbers and designations in the various drawings indicate like elements.

### DETAILED DESCRIPTION

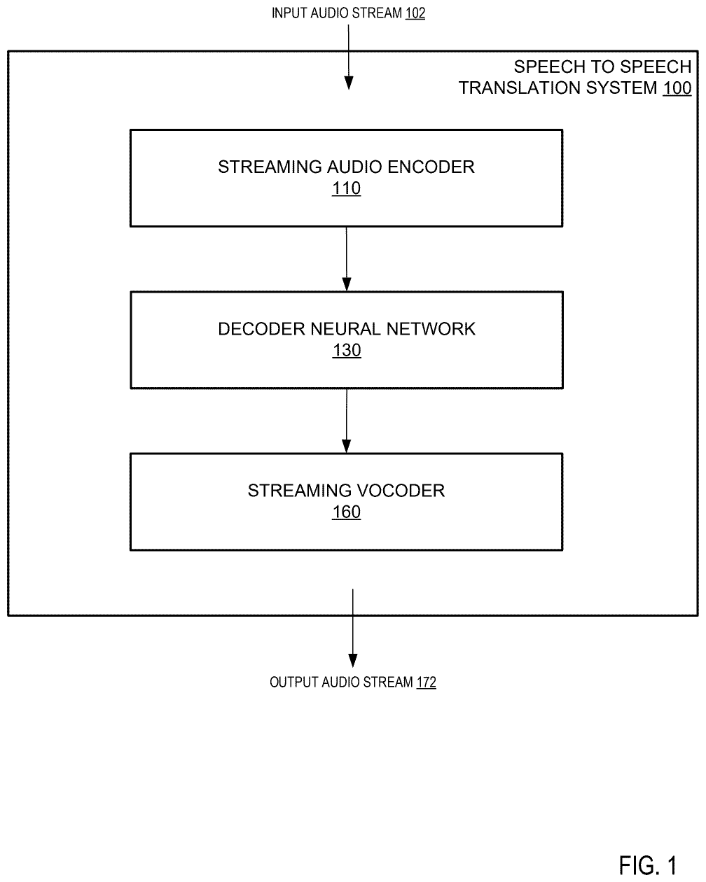

FIG. 1 shows an example speech-to-speech translation system 100 that includes a streaming audio encoder 110, a decoder neural network 130, and a streaming vocoder 160.

The speech-to-speech translation system 100 is an example of a system implemented as computer programs on one or more computers in one or more locations, in which the systems, components, and techniques described below can be implemented.

The speech-to-speech translation system 100 is a system that is configured to receive an input audio stream 102 representing input speech in a first (“source”) natural language and generate an output audio stream 172 representing output speech in a second different (“target”) natural language that is a translation of the input speech into the second natural language. For example, the first natural language can be Spanish, and the second natural language can be English. As another example, the first natural language can be Chinese, and the second natural language can be English. As another example, the first natural language can be German, and the second natural language can be French.

In some implementations, the system 100 is configured to perform translation between a single source language-target language pair. In some other implementations, the system 100 is configured to perform translation between multiple different source-target language pairs. In these cases, the system 100 can receive, along with the input audio stream 102, an input that identifies the source-target language pair, e.g., that identifies the target language that the speech should be translated into.

As a particular example, the system 100 can be configured to perform “streaming” speech-to-speech translation.

Generally, streaming translation refers to performing the translation such that the system 100 starts generating the output speech, e.g., output audio stream 172 before the input speech, e.g., input audio stream 102, is finished being received and continues to generate additional output speech as the input speech continues being received.

As a particular example, the system 100 can generate the output speech with a specified delay relative to receiving the input speech, i.e., so that a frame at a given time within the output speech is generated a fixed amount of time after the frame at the given time within the input speech is received. In this case, this fixed amount of time defines the delay between the input speech and the output speech. In particular, as will be described below, the amount of delay is defined by a frame window size that specifies how many input frames are processed before the system 100 begins generating the output frames. This frame window size is generally equal to k, with k being a positive integer and the value of k being fixed by the system 100 or received as input by the system 100.

As one example, the speech-to-speech translation system 100 can be implemented on an edge device, e.g., a mobile phone, a tablet computer, a smart home device, and so on, so that the speech-to-speech translation is performed on-device and without needing to transmit any information over a network or to any other device.

The input audio stream 102 can be any appropriate real-time speech input in a first language. For example, the input audio stream 102 can be real-time live human speech in a first language, e.g., speech from a live conversation. M ore specifically, the real-time live human speech can be speech from live meetings, conferences, customer service interactions, or any other live conversations. As another example, the input audio stream 102 can be real-time recorded speech in a first natural language, e.g., recorded announcements on public transportation.

The input audio stream 102 can be received in any appropriate manner, including through a microphone. In some implementations, the input audio stream 102 can be received through a microphone associated with the edge device.

To generate the output audio stream 172, the system 100 can process the input audio stream 102 using a streaming audio encoder 110 to generate an encoded audio sequence, i.e., a sequence of encoded audio frames. That is, the streaming audio encoder 110 can perform real-time encoding of an input audio stream 102 into one or more frames of an encoded audio sequence.

In this specification, an audio frame refers to a small segment of a continuous input audio stream that typically represents a short duration of time. That is, the input audio stream 102 can be split into multiple smaller segments (frames) as speech is received by the system.

The streaming audio encoder 110 can be any appropriate encoder neural network, with any appropriate architecture, including, but not limited to, a convolutional neural network (CNN), a Transformer neural network and a Conformer neural network.

A Conformer neural network is a neural network that includes both components of a CNN and a Transformer neural network. That is, a Conformer neural network can include both convolutional layers and self-attention layers to capture both global and local features of input data. As an example, the encoder 110 can include a sequence of Conformer neural network blocks that can include both self-attention layers and convolutional layers within the block. The self-attention layers can capture global dependencies and contextual information across the entire audio stream by weighing the importance of different parts of the input audio stream. On the other hand, the convolutional layers can capture patterns and features within an input audio frame by applying a set of filters to the input audio frame to detect patterns in the frame.

For real-time speech-to-speech translation, all of the layers of the Conformer neural network blocks are causal, meaning that the output corresponding to any given time in the audio signal depends only on the current and past inputs and not on future inputs.

The system 100 can decode the encoded audio frames using a decoder neural network 130 to translate the encoded audio frames representing speech in the first natural language to output audio frames representing translated speech in the second natural language.

For each encoded audio frame after the k-th encoded audio frame in the encoded audio sequence (where k is a fixed integer greater than or equal to one), i.e., for each encoded audio frame after an initial window of audio frames that has the window size described above, the system 100 can process the encoded audio frame using a decoder neural network 130 to generate an output audio frame.

When performing streaming translation, the system 100 can begin processing encoded audio frames using the decoder neural network 130 once the k+1th encoded audio frame has been generated (i.e., and before the k+2th encoded audio frame in the sequence has been generated by the streaming encoder). Thus, the value of k represents a configurable delay between beginning to receive the input audio signal and beginning to output the translation.

The decoder neural network 130 can include an attention layer block that, for each encoded audio frame, attends only over the k immediately preceding encoded audio frames in the encoded audio sequence and not over any audio frames that are earlier than the k immediately preceding encoded audio frames in the sequence relative to the current frame. That is, for each encoded audio frame, the attention layer block can attend only over a window of immediately preceding encoded audio frames in the encoded audio sequence having the frame window size described above relative to the current frame.

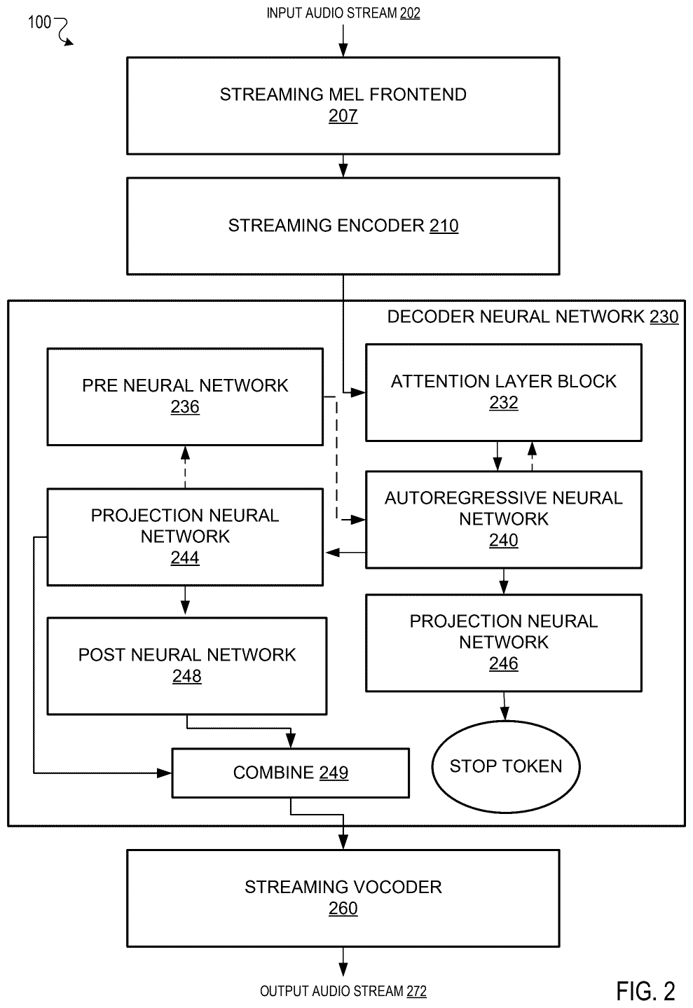

The architecture of the decoder neural network will be described in further detail below with reference to FIG. 2.

The system 100 can process the output audio frame using a streaming vocoder 160 to generate a time-domain audio waveform representing the output audio frame of the output audio stream 172.

The time-domain waveform can represent an output audio frame of output speech in any second natural language that differs from the first natural language of the input audio stream (as described above).

The streaming vocoder 160 can be any appropriate vocoder with any appropriate neural network architecture, including CNNs, diffusion neural networks, and generative adversarial networks (GANs).

As a specific example, the streaming vocoder 160 can be a GAN vocoder. To generate a time-domain audio waveform, a GAN vocoder can utilize one or more convolutional layers to refine the output audio frame to map the features of the output audio frame into an audio waveform. The GAN vocoder can be trained so that the generator can learn to produce high-quality audio waveforms that a discriminator cannot easily identify as fake when evaluating the quality of the generated audio waveform by distinguishing it from real audio samples.

In some implementations, the system 100 can output the output audio stream 172. The system 100 can output the output audio stream in any appropriate manner. In some implementations, the output audio stream 172 can be played through an audio output device associated with the edge device. For example, the output audio stream 172 can be played through a speaker associated with the edge device.

The streaming encoder 110 and the decoder neural network 130 of the speech-to-speech translation system 100 can be trained jointly to translate an input audio stream 102 in a first natural language into an output audio stream 172 in a second natural language, allowing the system 100 to optimize all components simultaneously and ensure seamless integration. That is, the speech-to-speech translation system 100 can train the streaming encoder 110 and the decoder neural network 130 jointly on a loss function.

The streaming vocoder 160 can be pre-trained separately from the encoder 110 and the decoder 130, e.g., on any appropriate vocoder training objective, e.g., an objective that measures how well the vocoder 160 maps output audio frames to audio waveforms.

The speech-to-speech translation system 100 can be trained on a set of training examples that include (i) source speech in the first natural language and (ii) translated speech that is a translation of the source speech into the second natural language.

The speech-to-speech translation system 100 can be trained on any appropriate loss function. For example, the speech-to-speech translation system 100 can be trained on a cross-entropy loss function. As another example, the speech-to-speech translation system 100 can be trained on a phoneme recognition loss function.

The speech-to-speech translation system 100 can train the decoder neural network and the encoder neural network by computing a gradient of the objective function with respect to the parameters of the decoder and the encoder, e.g., through backpropagation. The speech-to-speech translation system can then apply an optimizer to the gradients to update the parameters of the models. The system can use any appropriate optimizer to train the neural network, e.g. A dam, A dafactor, SGD, and so on.

FIG. 2 is a diagram that shows an example speech to speech translation by the speech-to-speech translation system 100.

The speech translation system 100 can include a streaming mel frontend 207, a streaming encoder 201, a decoder neural network 230, and a streaming vocoder 260.

The system 100 can receive an input audio stream 202, e.g., input speech in a first natural language and process the input audio stream 202 using a streaming mel frontend 207.

The streaming mel frontend 207 is a pre-processing component of the system 100 that can process the input audio stream 202 in real time to extract features from the audio stream 202 and represent the features in a way suitable for processing by machine learning models, e.g., mel-spectrogram frames.

In some implementations, as depicted in FIG. 2, the streaming mel frontend 207 can be a separate component from the streaming encoder 210. In some implementations, the streaming encoder 210 can include the streaming mel frontend component 207.

More specifically, the streaming mel frontend 207 component can continuously capture audio signals from the input audio stream 202 and segment the audio stream 202 into short, possibly overlapping audio frames as received. That is, each audio frame can correspond to a time window within the input audio stream 202.

The audio frames can be converted from the time domain to the frequency domain, using any appropriate technique. For example, the audio frames can be converted from the time domain to the frequency domain using a short-time fourier transform (ST FT). The streaming mel frontend 207 can then apply a transformation to the frequency domain representations of the audio frames, e.g., the STFT representations, to represent the audio frames in a mel scale.

The mel scale is designed to reflect the human ear's response to different frequencies and focuses on the most important frequency bands for human perception. By converting audio signals in the frequency domain to the mel scale, the system 100 can identify phonemes and other relevant speech features more effectively during encoding.

The representation of the audio frames in the mel scale are known as mel-spectrogram frames, from which the relevant speech features can be extracted and encoded by the streaming encoder 210.

As used in this specification, a mel-spectrogram frame can be represented by a vector of mel-scale frequency values.

At a high level, the streaming mel-frontend 207 can receive and process the input audio stream 202 in real time and generate mel-spectrogram frames using a mel scale that transforms features of the audio frame into easily extracted phonemes and other speech components. That is, the streaming mel frontend 207 can transform the audio data into a form that can be easily understood and processed by machine learning models, e.g., the streaming encoder 210, while maintaining the integrity of the audio stream and its features.

The system 100 can then input the mel-spectrogram frames to the streaming encoder 210 for encoding. As mentioned above, the streaming encoder 210 can process the mel-spectrogram frames by encoding the features to generate an encoded audio sequence, i.e., a sequence of encoded audio frames.

Each encoded audio frame in the sequence of encoded audio frames corresponds to each input audio frame and is a vector representation of the corresponded input audio frame.

After generating k+1 encoded audio frames, the system 100 can process the encoded audio frames using a decoder neural network 230 to generate output audio frames that represent a translation of the input speech into the second natural language. That is, after an initial accumulation of k encoded audio frames, which establish the fixed contextual delay, the decoder neural network 230 can start generating translated output audio frames employing the context audio input accumulated due to the delay. In other words, each output audio frame can represent a translation of the input speech and context that has been accumulated up to that point. The output audio frames can be of a different size, i.e., can correspond to a different time window, than the input audio frames. For example, the output audio frames can correspond to a larger time window than the input audio frames.

As described above, the system 100 can process the encoded audio frames sequentially, with a slight delay from real-time, as they are received and processed by the streaming mel-frontend 207 and streaming encoder 210. That is the decoder neural network 230 can generate the output audio features of the translated speech frame-by frame by processing one encoded audio frame at a time, while conditioned on the k-preceding encoded audio frames.

To generate the output audio frames, the decoder neural network 230 can include one or more neural networks and neural network layers, including one or more attention layers, one or more auto-regressive neural network layers, one or more post-neural network layers, and one or more projection layers.

As a particular example, the decoder 230 can include an attention layer block 232 that includes one or more attention layers, an auto-regressive neural network 240 that can include one or more auto-regressive neural network layers, one or more projection neural networks (e.g., projection neural networks 244 and 246) that can include one or more projection layers, and a post-neural network 248 that can include one or more post-neural network layers.

As used in this specification, an attention layer block 232 is a sequence of neural network layers that includes one or more attention layers and, optionally, one or more other types of neural network layers, e.g., fully-connected layers, normalization layers, or residual connection layers.

In some implementations, the projection neural networks 244 and 246 can be the same projection neural network. In some implementations, the projection neural networks 244 and 246 are two separate and distinct projection neural networks.

In some implementations, the decoder neural network 230 can further include a pre-neural network 236.

As a particular example, the decoder neural network 230 can be a streaming decoder neural network. M ore specifically, as described above, the decoder 230 can perform real-time sequential processing of the encoded audio frames, frame by frame until a stop token is reached, signaling the end of the input audio stream 202.

As part of the processing of the encoded audio frame by the decoder neural network 230, the system 100 can apply an attention mechanism using an attention layer block 232 to the encoded audio frame and the k immediately preceding encoded audio frames in the encoded audio sequence to generate an attention context (i.e., the window of immediately preceding encoded audio frames in the encoded audio sequence having the frame window size described above).

That is, the attention mechanism can attend only over the k immediately preceding encoded audio frames in the encoded audio sequence and not over any audio frames that are earlier than the k immediately preceding encoded audio frames in the sequence relative to the current frame.

As a particular example, the attention mechanism can be configured to apply each of a query transformation, a key transformation, and a value transformation to the attention layer input for each encoded audio frame of the k-immediately preceding encoded audio frames to derive a respective query vector, key vector, and value vector which are used to determine the attention context. The query, key and value transformation can be any respective linear transformation or any other appropriate learned transformation. For example, the attention mechanism can generate an attention context for the current encoded audio frame representing a weighted sum of the values of the k-immediately preceding encoded audio frames, weighted by a similarity function of the query for the k-immediately preceding encoded audio frames to the corresponding key. The similarity function may comprise, e.g., a dot product, cosine similarity, or other similarity measure. That is, the attention mechanism can generate an attention context, e.g., a context vector, by for each of the k-preceding audio frames, multiplying the corresponding value of the previous encoded audio frame, e.g., one of the k-preceding audio frames, by a similarity function of the query of the encoded audio frame to the corresponding key and combining the products for each of the k-preceding audio frames.

Each query, key, value can be a vector that includes one or more vector elements. The attention context can also be a vector that includes one or more vector elements. The attention context vector can be a weighted sum of the encoder outputs where the weights are the attention scores.

In some cases, because the attention applied by the attention mechanism is causal, the system 100 can store, for any given attention mechanism, and when generating the attention context for any given encoded audio frame, the previous encoded audio frames, or the keys and values already computed for previous encoded audio frames rather than re-computing the keys and values for earlier time steps.

Thus, storing keys and values in a memory for later re-use will generally be referred to as storing the keys and values in a “KV cache.”

The decoder neural network 230 can process an input including the attention context, e.g., the context vector that represents an updated frame corresponding to the (current) encoded frame after being processed by the attention layer block 232, generated by the attention layer block 232 using an auto-regressive neural network 240 to generate an auto-regressive output for the encoded audio frame.

For example, the auto-regressive neural network 240 can receive an input that includes the attention context generated by the attention layer block 232 and process the input to generate an auto-regressive output.

In some implementations, the auto-regressive neural network 240 can receive an input that includes the attention context generated by the attention layer block 232 and the current encoded audio frame and process the input to generate an auto-regressive output.

In some implementations, the auto-regressive neural network 240 can also receive data representing the output audio frame from the previous decoding step to help the auto-regressive learn effective attention weights (e.g., learn the relevant information in the (current) encoded audio frame better with context from the (previous) output audio frame. For example, the auto-regressive neural network 240 can receive the data representing the output audio frame from a pre-neural network 236.

The output audio frame and the pre-neural network 236 are described in further detail below.

In some implementations, the auto-regressive neural network 240, can utilize its updated hidden state after decoding to help influence the attention scores for the next decoding step. That is, the updated hidden state of the auto-regressive neural network 240 can influence the context vector for the next encoded audio frame. In other words, the attention layer block 232 can receive the updated hidden state of the autoregressive neural network 240 (from the previous decoding step) as input to help compute the context vector for the (current) encoded audio frame.

The auto-regressive output can be a decoded output audio frame. For example, the auto-regressive output can be an output mel-spectrogram frame that represents the translation of the input speech into a second natural language.

The auto-regressive neural network 240 can be any appropriate auto-regressive neural network that is configured to process inputs sequentially. In some implementations, the auto-regressive neural network 240 is a recurrent neural network.

As a specific example, the recurrent neural network can be a long short-term memory (LSTM) neural network.

The decoder neural network 230 can process the auto-regressive output using a projection neural network 244 to generate an initial output audio frame.

The projection neural network 244 can be any appropriate projection neural network.

The projection neural network 244 can reduce the dimensions of the auto-regressive output to generate the initial output audio frame. That is, the projection neural network 244 can reduce the dimensions of the auto-regressive output to match the required input dimensions of the next layer of the decoder neural network 230.

The decoder neural network 230 can process an input including the initial output audio frame using the post neural network 248 to generate a residual output.

The post neural network can be any appropriate neural network. In some implementations, the post neural network 248 can be a causal convolutional neural network.

As a specific example, the casual convolutional neural network can process an input that includes the initial output audio frame and the preceding initial output audio frames using one or more convolutional layers to capture local dependencies and patterns in the sequence of audio frames (e.g., initial output audio frame and the preceding initial output audio frames) to generate a residual output. The residual output can represent the refined information captured by the causal CNN, e.g., the residual output might highlight important features or correct minor errors in the initial output audio frame.

The decoder neural network 230 can combine 249 the residual output (e.g., from the post neural network 248) and the initial output audio frame (e.g., from the projection neural network 244) to generate the output audio frame.

In some implementations, the residual output can be a vector that includes one or more vector elements. In some implementations, the initial output audio frame is a mel-spectrogram frame that is represented by a vector of mel-scale frequency values.

The residual output and the initial output audio frame can be combined using any appropriate method. In some implementations, the residual output and the initial output audio frame can be combined using element-wise addition.

In some implementations, the decoder neural network 230 can include a pre-neural network 236.

The decoder neural network 230 can process an input including a preceding output audio frame, a preceding initial output audio frame or both using a pre-neural network to generate a projected audio frame. That is, the input to the auto regressive neural network can include the attention context and the projected audio frame.

In other words, the decoder neural network 230 can pass the initial output audio frame (generated by the projection neural network 244) through the pre-neural network 236 to influence the decoding process of the next encoded audio frame in the sequence. That is, the pre-neural network 236 can process the initial output audio frame and pass the output back to the auto-regressive neural network 240 to help the auto-regressive neural network 240 learn effective attention weights for the next encoded audio frame. In other words, when decoding an encoded audio frame, the decoder neural network 230 can pass the output audio frame to (i) a post neural network, e.g., the post neural network described above, to be output from the system, and (iii) a pre-neural network to act as an informational bottleneck for the decoding of the next encoded audio frame by the auto-regressive neural network 240.

The pre-neural network 236 can include one or more fully-connected layers that compress the initial output audio frame into a smaller representation, compressing the information in the frame.

The projected audio frame can be passed to the auto-regressive neural network that uses this information to aid the contextualization of the (current) encoded audio frame,

In some implementations, the projected audio frame can be passed through the auto-regressive neural network and further passed back to the attention layer block 323 and can aid the attention mechanism in focusing on the most relevant parts of the input sequence of the next encoded audio frame so that the attention mechanism can better align the current input with the past context.

The decoder neural network 230 can repeat the above decoding process for each encoded audio frame until a stop token is generated, denoting the end of the input audio stream and thus, the decoding process.

The stop token can be generated by passing the decoder output audio frame through the projection neural network 246 and an activation function (e.g., a ReLU activation function) to predict the probability that the sequence has completed. That is, the stop token can be generated through a prediction mechanism of the decoder neural network 230. Because the decoder neural network 230 generates encoded audio frames one frame at a time, the decoder 230 can determine when the sequence is complete and generate the stop token. In particular, the decoder neural network 230 can be trained to recognize patterns that indicate the end of the translation and to predict the stop token in the training data so that during translation, the decoder 230 can recognize when to terminate the decoding process.

The output audio frame can be passed through the projection neural network 246 and the stop token can be generated when the score that represents the likelihood that the sequence is complete meets or exceeds a threshold value.

The streaming vocoder 260 can receive the output audio frame, e.g., mel-spectrogram audio frame, and convert the generated audio features in the output audio frame into a time-domain audio waveform that represents a segment of the output audio stream 272.

The time domain audio waveform can represent the audio characteristics of the decoded audio features, e.g., the audio features of the translated speech, in a natural-sounding audio output. The time-domain audio waveform can be output as a portion of the output audio stream 272 of the system 100 as described above with reference to FIG. 1.

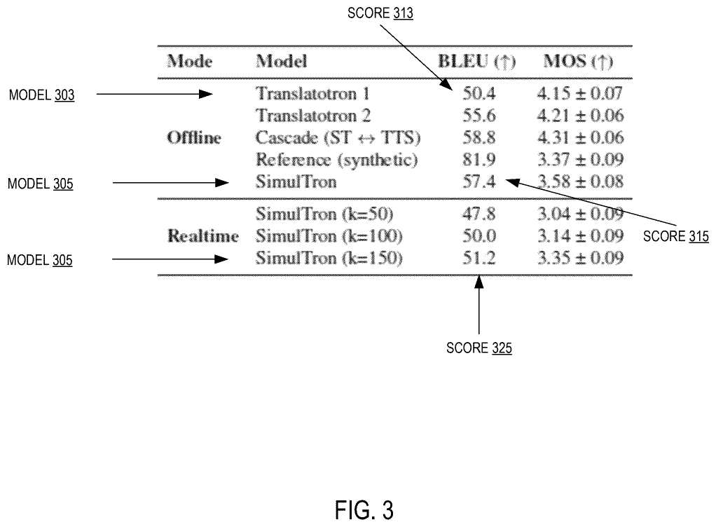

FIG. 3 compares the performance of the speech-to-speech translation system with previous models.

The table 300 showcases the performance of one or more models on a conversational Spanish-to-English dataset by using a bilingual evaluation understudy (BLEU) metric to measure the quality of the machine translated text.

The BLEU metric can be used to evaluate the quality of translations by comparing it to one or more reference translations. That is, the BLEU metric measures how many words or phases in the machine translation match those in the reference translations considering one or more other factors.

The model 305, i.e., the model described in this specification, demonstrates a score 315 of 57.4 during offline translation and a score 325 of 51.2 during real-time translation.

As compared to other models, the model 305 exhibits improved or around equivalent performance. For example, the model 305 has a higher score 315 than model 303 has with score 313 for offline translation. Even in real-time translation, model 305 exhibits a performance improvement of 0.8 in score 325 over score 313.

That is, the model 305, i.e., the model described in this specification, produces a higher quality of translation than model 303, even when generating the translation in real-time, which poses more difficulty.

Thus, the model 305 can successfully improve offline translation compared to other speech-to-speech translation models and produce high quality real-time translation.

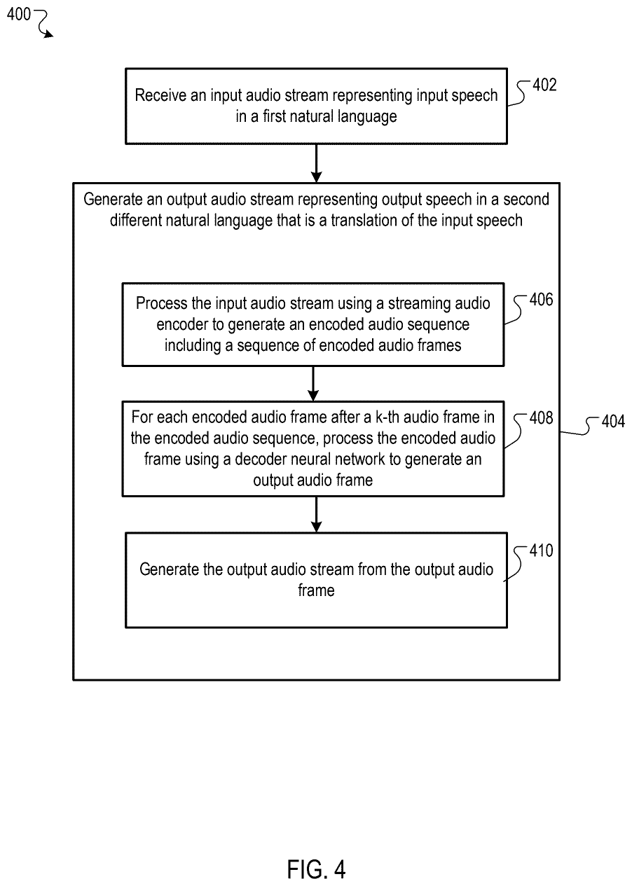

FIG. 4 is a flow diagram of an example speech-to-speech translation process.

For convenience, the process 400 of FIG. 4 will be described as being performed by a system of one or more computers located in one or more locations. For example, a speech-to-speech translation system, e.g., the speech-to-speech translation system 100 depicted in FIG. 1, appropriately programmed in accordance with this specification, can perform the process 400.

The system can receive an input audio stream representing input speech in a first natural language (step 402).

The input audio stream can be input speech in any first natural language. For example, the input audio stream can be input speech in Spanish.

The system can generate an output audio stream representing output speech in a second different natural language that is a translation of the input speech into the second natural language (step 404).

The output audio stream can be output speech in any second natural language that differs from the first natural language. For example, the input audio stream can be output speech in English.

The below steps (406-412) are sub-steps of step 404 and further detail the generation process of the output audio stream.

The system can process the input audio stream using a streaming audio encoder to generate an encoded audio sequence comprising a sequence of encoded audio frames (step 406).

In some implementations, the system can process the input audio stream using a streaming mel frontend as described above with reference to FIG. 2.

The streaming mel-frontend can process the input audio stream in real time and generate mel-spectrogram frames using a mel scale that transforms features of the audio frame into easily extracted phonemes and other speech components.

The system can then input the mel-spectrogram frames to the streaming encoder for encoding. The streaming encoder can extract the speech features from the mel-spectrogram frames and then encode the features to generate an encoded audio sequence, i.e., a sequence of encoded audio frames.

For each encoded audio frame after an initial window of initial encoded audio frame in the encoded audio sequence having the frame window size, the system can process the encoded audio frame using a decoder neural network to generate an output audio frame (step 408).

In particular, the amount of delay is defined by a frame window size that specifies how many input frames are processed before the system 100 begins generating the output frames. This frame window size is generally equal to k, with k being a positive integer and the value of k being fixed by the system or received as input by the system.

The system can begin processing encoded audio frames using the decoder once the k+1th encoded audio frame has been generated (i.e., and before the k+2th encoded audio frame in the sequence has been generated by the streaming encoder). Thus, the value of k represents a configurable delay between beginning to receive the input audio signal and beginning to output the translation.

The decoder can include one or more neural networks and neural network layers, including one or more attention layers, one or more auto-regressive neural network layers, and one or more projection layers.

In some implementations, the decoder can include an attention layer block, an auto-regressive neural network, a projection neural network, and a post-neural network.

In some implementations, the decoder neural network can further include a pre-neural network.

Using the one or more neural networks and neural network layers, the decoder neural network can process the encoded audio frame to generate an output audio frame.

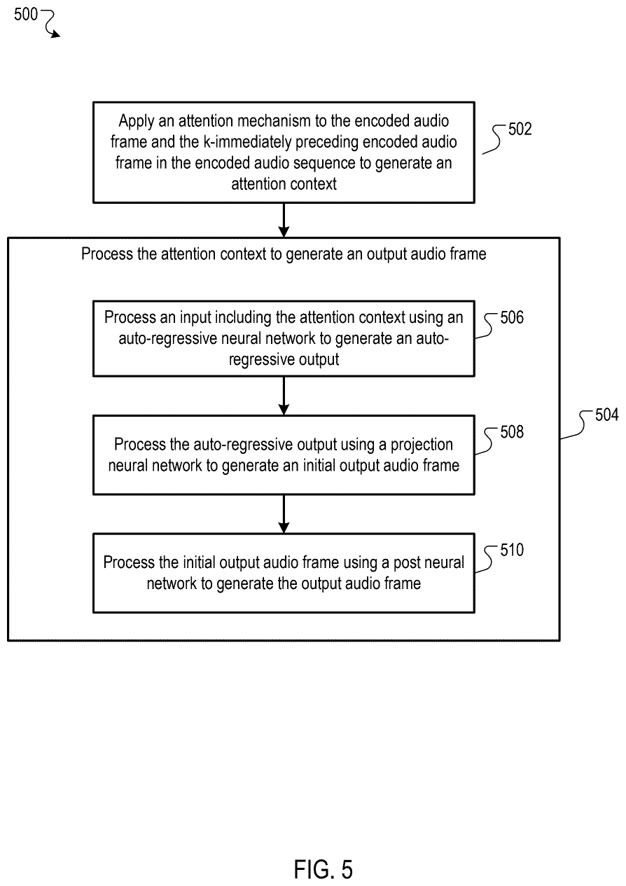

The processing of the encoded audio frames by the decoder neural network are described in further detail below with reference to FIG. 5.

The system can generate the output audio stream from the output audio frame (step 410).

As the decoder neural network generates output audio frames, the system can pass the output audio frames through a vocoder neural network to generate time domain audio waveforms that represent translated speech in the second natural language.

The processing of the output audio frames by the vocoder neural network is described in further detail above with reference to FIGS. 1 and 2.

The time domain audio waveforms can be output from the system as the output audio stream. That is, as the time domain audio waveforms are generated, they can be output from the system to produce real-time translated speech (with a delay as described above).

FIG. 5 is a flow diagram of sub-steps of step 412 of FIG. 4.

For convenience, the process 500 of FIG. 4 will be described as being performed by a system of one or more computers located in one or more locations. For example, a speech-to-speech translation system, e.g., the speech-to-speech translation system 100 depicted in FIG. 1, appropriately programmed in accordance with this specification, can perform the process 500.

The below steps are sub-steps of step 408 and further detail the processing of the encoded audio frames by the decoder neural network.

The decoder neural network can include an attention layer block, an auto-regressive neural network, one or more projection networks, and a post neural network.

In some implementations, the decoder neural network can further include a pre neural network.

The system can apply an attention mechanism to the encoded audio frame and a window of immediately preceding encoded audio frames in the encoded audio sequence having the frame window size to generate an attention context (step 502).

That is, the attention mechanism can attend only over the k immediately preceding encoded audio frames in the encoded audio sequence and not over any audio frames that are earlier than the k immediately preceding encoded audio frames in the sequence relative to the current frame (e.g., the window of immediately preceding encoded audio frames in the sequence having a frame window size as described above).

As a particular example, the attention mechanism can be configured to apply each of a query transformation, a key transformation, and a value transformation to the attention layer input for each encoded audio frame of the k-immediately preceding encoded audio frames to derive a respective query vector, key vector, and value vector which are used to determine the updated encoded audio frame. The query, key and value transformation can be any respective linear transformation or any other appropriate learned transformation. For example, the attention mechanism can generate an attention context for the current encoded audio frame representing a weighted sum of the values of the k-immediately preceding encoded audio frames, weighted by a similarity function of the query for the k-immediately preceding encoded audio frame to the corresponding key. The similarity function may comprise, e.g., a dot product, cosine similarity, or other similarity measure. That is, the attention mechanism can generate an attention context, e.g., a context vector, by multiply the corresponding value of the encoded audio frame, e.g., one of the k-preceding audio frames, by a similarity function of the query of the encoded audio frame to the corresponding key and adding the products up.

The attention context vector can be a weighted sum of the encoder outputs where the weights are the attention scores. That is, the attention context is a context vector that represents an updated frame corresponding to the (current) encoded frame after being processed by the attention layer block of the decoder neural network.

The system can process the attention context to generate an output audio frame (step 504).

The system can process the attention context using any of the neural network layers of the decoder neural network.

In some implementations, the decoder neural network can process the attention context with the auto-regressive neural network, the one or more projection neural network, and the post-neural network.

In some implementations, the decoder neural network can further process the attention context using a pre-neural network.

The below steps (506-510) are sub-steps of step 504 and further detail how the one or more neural network layers process the attention context to generate an output audio frame.

The system can process an input including the attention context using an auto-regressive neural network to generate an auto-regressive output (step 506).

The auto-regressive neural network can be any appropriate auto-regressive neural network that is configured to process inputs sequentially.

In some implementations, the auto-regressive neural network is a recurrent neural network. For example, the recurrent neural network can be a long short-term memory (LSTM) neural network.

In some implementations, the auto-regressive neural network can further receive an input from the pre neural network that includes a projected audio frame, where the projected audio frame is generated by the pre neural network by processing a preceding output frame, a preceding initial output frame or both. In other words, the auto-regressive neural network can further receive one or more outputs from the decoding process of the previous encoded audio frame to help influence the decoding process of the (current) encoded audio frame.

The auto-regressive neural network can utilize the preceding output audio frame and/or the preceding initial output audio frame to provide contextual information for the (current) encoded audio frame and learn effective attention weights by helping the model understand which parts of the encoded audio frame are relevant.

The system can process the auto-regressive output using a projection neural network to generate an initial output audio frame (step 508).

The projection neural network can reduce the dimensions of the auto-regressive output to generate the initial output audio frame. That is, the projection neural network can reduce the dimensions of the auto-regressive output to match the required input dimensions of the next layer of the decoder neural network.

The projection neural network can be any appropriate projection neural network. As an example, the projection neural network can be one or more fully-connected layers.

In some implementations, the system can further process the initial output audio frame using a post neural network to generate the output audio frame (step 510).

That is, the system can process an input comprising the initial output audio frame using a post neural network to generate a residual output.

In some implementations, the post-neural network is a causal convolutional neural network.

As a specific example, the casual convolutional neural network can process the input that includes the initial output audio frame and the preceding initial output audio frames using one or more convolutional layers to capture local dependencies and patterns in the sequence of audio frames (e.g., the initial output audio frame and the preceding output audio frames) to generate a residual output. The residual output can represent the refined information captured by the causal CNN, e.g., the residual output might highlight important features or correct minor errors in the initial output audio frame. That is, the residual output can be generated to improve the quality of the translation.

In some implementations, the residual output can be a vector that includes one or more vector elements.

The system can combine the residual output and the initial output audio frame to generate the output audio frame.

The system can combine the residual output and the initial output audio frame using any appropriate method. In some implementations, the residual output is represented by a vector and the initial output audio frame is represented by a vector and the two vectors can be combined using element-wise addition.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an A SIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an A SIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are corresponded to in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes corresponded to in the accompanying figures do not necessarily require the particular order shown, or sequential order, to achieve desirable results. In some cases, multitasking and parallel processing may be advantageous.

What is claimed is:

1. A method performed by one or more computers and for performing real-time translation of speech with a time delay that is specified by a frame window size, the method comprising:
receiving an input audio stream representing input speech in a first natural language; and
generating an output audio stream representing output speech in a second different natural language that is a translation of the input speech into the second natural language, comprising:
processing the input audio stream using a streaming audio encoder to generate an encoded audio sequence comprising a sequence of encoded audio frames;
for each encoded audio frame after an initial window of initial encoded audio frame in the encoded audio sequence having the frame window size, processing the encoded audio frame using a decoder neural network to generate an output audio frame, the processing comprising:
applying an attention mechanism to the encoded audio frame and a window of immediately preceding encoded audio frames in the encoded audio sequence having the frame window size to generate an attention context; and
processing the attention context to generate an output audio frame.

2. The method of claim 1, further comprising: outputting the output audio stream.

3. The method of claim 1, wherein the generating the output audio stream is performed by an edge device.

4. The method of claim 3, wherein the input audio stream is received through a microphone associated with the edge device.

5. The method of claim 3, further comprising: playing the output stream through an audio output device associated with the edge device.

6. The method of claim 1, wherein generating the output audio stream further comprises:
processing the output audio frame using a streaming vocoder to generate a time-domain audio waveform.

7. The method of claim 1, wherein, for each particular encoded audio frame that is after an initial window of initial encoded audio frame in the encoded audio sequence having the frame window size, the processing of the particular encoded audio frame using the decoder neural network is initiated before the encoded audio frame that is after the particular encoded audio in the sequence is generated.

8. The method of claim 1, wherein processing the attention context to generate an output audio frame comprises:
processing an input comprising the attention context using an auto-regressive neural network to generate an auto-regressive output; and
processing the auto-regressive output using a projection neural network to generate an initial output audio frame.

9. The method of claim 8, further comprising:
processing an input comprising the initial output audio frame using a post neural network to generate the output audio frame.

10. The method of claim 9, wherein the post neural network is a causal convolutional neural network.

11. The method of claim 9, wherein processing an input comprising the initial output audio frame using a post neural network to generate the output audio frame comprises:
processing an input comprising the initial output audio frame using the post neural network to generate a residual output; and
combining the residual output and the initial output audio frame to generate the output audio frame.

12. The method of claim 8, wherein the auto-regressive neural network is a recurrent neural network.

13. The method of claim 12, wherein the recurrent neural network is a long short-term memory (LSTM) neural network.

14. The method of claim 8, wherein processing the attention context to generate an output audio frame further comprises:
processing an input comprising a preceding output audio frame, a preceding initial output audio frame, or both using a pre neural network to generate a projected audio frame, and wherein the input to the auto-regressive neural network comprises the attention context and the projected audio frame.

15. The method of claim 1, wherein the streaming encoder comprises a sequence of causal Conformer neural network blocks.

16. A system comprising:
one or more computers; and
one or more storage devices communicatively coupled to the one or more computers, wherein the one or more storage devices store instructions that, when executed by the one or more computers, cause the one or more computers to perform operations for performing real-time translation of speech with a time delay that is specified by a frame window size comprising:
receiving an input audio stream representing input speech in a first natural language; and
generating an output audio stream representing output speech in a second different natural language that is a translation of the input speech into the second natural language, comprising:
processing the input audio stream using a streaming audio encoder to generate an encoded audio sequence comprising a sequence of encoded audio frames;
for each encoded audio frame after an initial window of initial encoded audio frame in the encoded audio sequence having the frame window size, processing the encoded audio frame using a decoder neural network to generate an output audio frame, the processing comprising:
applying an attention mechanism to the encoded audio frame and a window of immediately preceding encoded audio frames in the encoded audio sequence having the frame window size to generate an attention context; and
processing the attention context to generate an output audio frame.

17. One or more non-transitory computer storage media storing instructions that when executed by one or more computers cause the one or more computers to perform operations and for performing real-time translation of speech with a time delay that is specified by a frame window size comprising:
receiving an input audio stream representing input speech in a first natural language; and
generating an output audio stream representing output speech in a second different natural language that is a translation of the input speech into the second natural language, comprising:
processing the input audio stream using a streaming audio encoder to generate an encoded audio sequence comprising a sequence of encoded audio frames;
for each encoded audio frame after an initial window of initial encoded audio frame in the encoded audio sequence having the frame window size, processing the encoded audio frame using a decoder neural network to generate an output audio frame, the processing comprising:
applying an attention mechanism to the encoded audio frame and a window of immediately preceding encoded audio frames in the encoded audio sequence having the frame window size to generate an attention context; and
processing the attention context to generate an output audio frame.
